(19) United States
(12) Patent Application Publication
(10) Pub. No.: US 2019/0337549 A1
(43) Pub. Date: Nov. 7, 2019

(54) SYSTEMS AND METHODS FOR TRANSACTIONS AT A SHOPPING CART

(71) Applicant: Walmart Apollo, LLC, Bentonville, AR (US)

(72) Inventors: Charles Lobo, Cave Springs, AR (US); Jinzhi Zhang, San Jose, CA (US)

(21) Appl. No.: 16/402,138

(22) Filed: May 2, 2019

Related U.S. Application Data
(60) Provisional application No. 62/665,599, filed on May 2, 2018.

(51) Int. Cl. B62B 5/00; B62B 3/14; G06Q 20/20; G06Q 20/40; G06K 9/00; G06K 9/62

(52) U.S. Cl. CPC B62B 5/0096; B62B 3/14; G06Q 20/208; G06K 9/00221; G06Q 20/4016; G06K 9/00201; G06K 9/6202; G06Q 20/203

(57) ABSTRACT

Exemplary embodiments provide a system, a method, and computer-readable medium to facilitate a transaction at a shopping cart. A first image of a user's face is captured by a first camera at a device coupled to the shopping cart, and the first image is stored in a database. A second image of the user's face is captured by a second camera when one or more sensors at a fixture detect an item is being removed from the fixture. The second image is analyzed and it is determined that the face in the second image corresponds to the face in the first image. Product information corresponding to the item removed from the fixture is sent to the processing device associated with the user captured in the first and second images. The product information is stored at the processing device for completion of a transaction by the user.

### CROSS-REFERENCE TO RELATED PATENT APPLICATIONS

This application claims priority to U.S. Provisional Application No. 62/665,599, filed on May 2, 2018, the content of which is hereby incorporated by reference in its entirety

### BACKGROUND

Today customers may complete purchase transactions themselves while shopping in a store. A customer may use an application that executes on a mobile device, such as a smartphone or tablet to scan items for purchase in the store and submit payment via the application.

### BRIEF DESCRIPTION OF DRAWINGS

Some embodiments are illustrated by way of example in the accompanying drawings and should not be construed to limit the present disclosure:

FIG. 1 is a block diagram showing a transaction system implemented in modules, according to an example embodiment;

FIG. 2 is a flowchart showing an example method for facilitating a transaction at a shopping cart, according to an example embodiment;

FIG. 3 is a flowchart showing another example method for facilitating a transaction at a shopping cart, according to an example embodiment;

FIG. 4 schematically depicts various components of the transaction system, according to an example embodiment;

FIG. 5 illustrates a network diagram depicting a system for implementing the transaction system, according to an example embodiment; and

FIG. 6 is a block diagram of an exemplary computing device that may be used to implement exemplary embodiments of the transaction system described herein.

### DESCRIPTION OF EXEMPLARY EMBODIMENTS

Described in detail herein are systems, methods, and computer-readable medium for a transaction system to facilitate transactions at a shopping cart. In exemplary embodiments, a shopping cart is coupled to a processing device and one or more sensors, including a camera. A customer can use such a cart to select items for purchase and complete the purchase transaction at the cart without visiting a checkout lane or interfacing with a cashier. The customer can select a shopping cart coupled to a processing device, turn on the processing device, and enter an input to begin the transaction. In an example embodiment, the customer scans an identification code at the cart or processing device using his mobile device to pair his mobile device with the cart. At this point, the camera coupled to the cart captures an image of the customer and stores it in a database as associated with the processing device to identify the cart being used by the customer.

The systems and methods disclosed herein can be configured to comply with privacy requirements, which may vary between jurisdictions. For example, at the time of pairing the customer with the cart and before any capturing or processing of images of the customer, a “consent to capture” process may be implemented. In such a process, consent may be obtained, from the customer, via a registration process. Part of the registration process may be to ensure compliance with the appropriate privacy laws for the location where the systems and methods would be performed. The registration process may include certain notices and disclosures made to the user prior to the user recording the user's consent. No unauthorized collection or processing of images of individuals occurs via exemplary systems and methods.

As the customer shops and selects items to purchase, the customer scans the item at the processing device via a scanner at the cart or via his mobile device prior to placing the items in the shopping cart to purchase. In some instances, customers may not scan one or more items before placing the items in the cart. For example, the customer may forget to scan the items. To ensure that such items are accounted for, the cart and/or surrounding environment includes one or more sensors and/or cameras to detect and identify items being placed in the cart.

In exemplary embodiments, sensors and cameras are disposed in the aisles and on the fixtures (e.g., shelves) to detect when an item is removed from the shelf. When an item is removed from the fixture and placed in the shopping cart, the camera or cameras in the aisles (e.g., on the ceiling in the aisles) captures an image of the face of the customer removing the item from the fixture. The face in this image is analyzed to match a face captured in images by cameras coupled to the carts. Once the image with the customer's face is identified, the processing device associated with that image is identified. Product information for the item removed from the fixture and placed in the cart is transmitted to the identified processing device.

In an example embodiment, if there is a mismatch between the number of items scanned at the processing device and the items detected as being placed in the cart, then an alert is generated to an associate's device to perform a manual check of the items in the customer's cart.

An alert may be generated to an associate's device to perform a manual check of the items in the customer's cart. If an item is identified as being placed in the cart, but it is not scanned at the processing device, then an alert is generated to an associate's device to perform a manual check of the items in the customer's cart.

In some embodiments, the customer's mobile device includes a transaction application (app) that enables the customer to scan items for purchase. The customer's mobile device may be in communication with the processing device of the cart to receive and transmit data relating to items being scanned at the mobile device and placed in the cart. The customer can complete the transaction and tender payment via the transaction app on his mobile device.

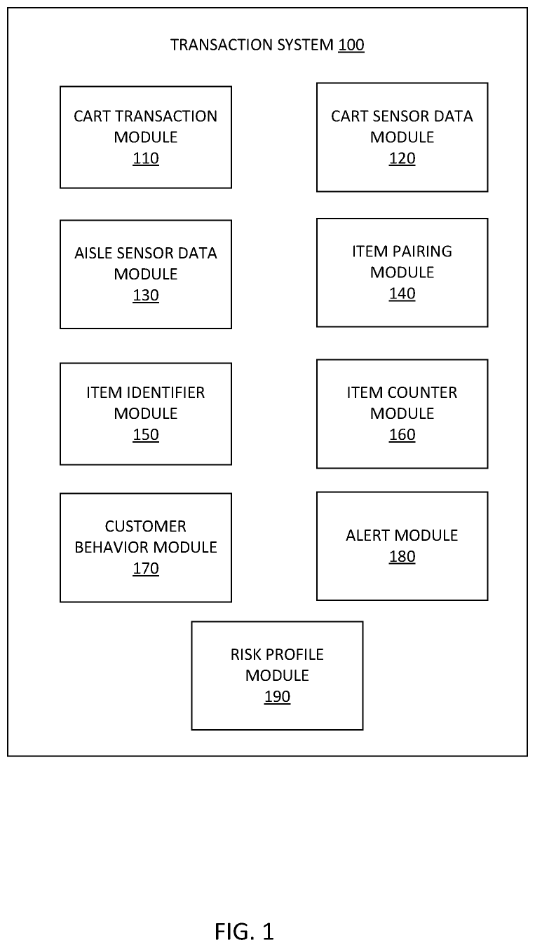

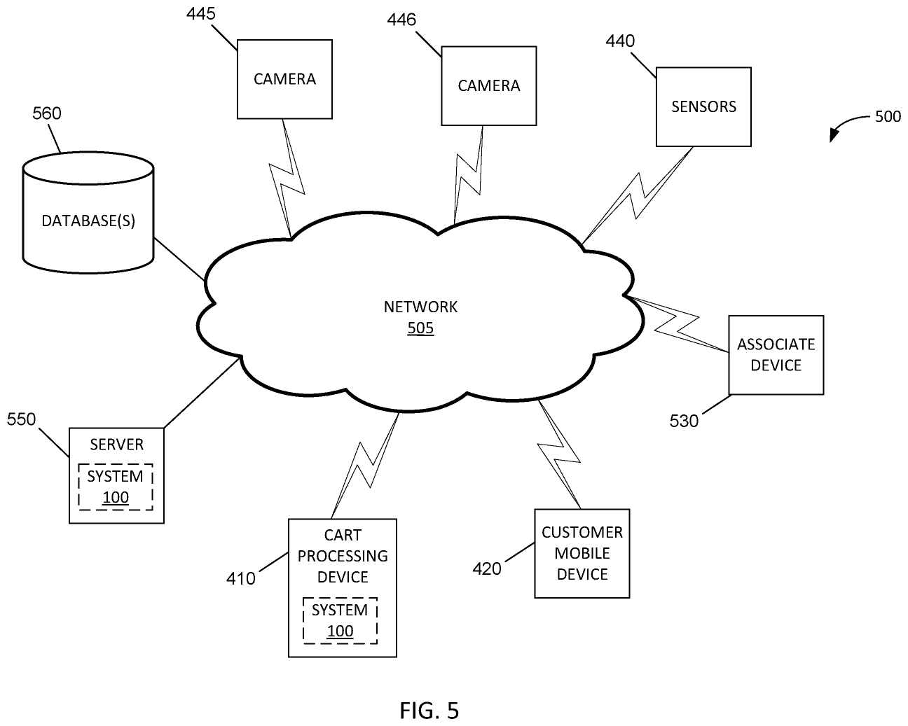

FIG. 1 is a block diagram showing a transaction system 100 in terms of modules according to an example embodiment. The modules may be implemented in cart processing device 410 or server 550 shown in FIG. 5. The modules include a cart transaction module 110, cart sensor data module 120, aisle sensor data module 130, item pairing module 140, item identifier module 150, item counter module 160, customer behavior module 170, alert module 180, and risk profile module 190. The modules may include various circuits, circuitry and one or more software components, programs, applications, apps or other units of code base or instructions configured to be executed by one or more processors included in cart device 410 or server 550. Although modules 110, 120, 130, 140, 150, 160, 170, 180 and 190 are shown as distinct modules in FIG. 1, it should be understood that modules 110, 120, 130, 140, 150, 160, 170, 180 and 190 may be implemented as fewer or more modules than illustrated. It should be understood that any of modules 110, 120, 130, 140, 150, 160, 170, 180 and 190 may communicate with one or more components included in system 500 (FIG. 5), such as cart processing device 410, customer mobile device 420, associate device 530, sensors 440, cameras 445, 446, server 550, and database(s) 560.

The cart transaction module 110 can be configured to receive data from a scanner coupled to or associated with the cart, where a customer scans items prior to placing them in the shopping cart. The data may include product information such as a Universal Product Code (UPC), item name, item price, model number, brand name, item type (e.g., beauty product, home improvement, cold food, hot food, etc.), item size, item weight, item color, price, and the like. The data may be stored in a database (e.g., database(s) 560 of FIG. 5). The cart transaction module 110 may also be configured to perform a purchase transaction via the processing device coupled to the cart, enabling the customer to complete purchase of the items added to the cart without having to go to a checkout lane. The cart transaction module 110 is also configured to associate the processing device coupled to the cart to the customer using the cart, and store the association in a database.

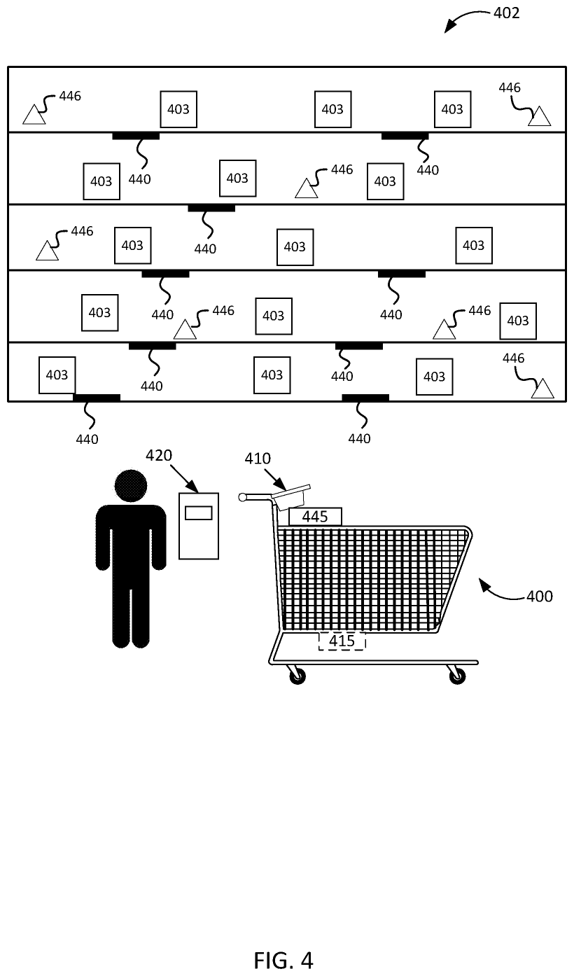

The cart sensor data module 120 can be configured to receive and manage data sensed by various sensors coupled to the shopping cart. The cart sensor data module 120 may also be configured to operate the various sensors coupled to the shopping cart. For example, the cart sensor data module 120 may activate the camera (e.g., first camera 445 shown in FIG. 4) coupled to the cart to capture a first image of the customer in response to the customer logging in the processing device coupled to the cart. The cart sensor data module 120 may receive sensed data from sensors coupled to the cart, such as a camera, weight sensor, laser sensor, optical sensor, motion detection sensor, color sensor, and the like. The cart sensor data module 120 may store the sensed data in a database (e.g., database(s) 560 shown in FIG. 5).

The aisle sensor data module 130 can be configured to receive and manage data sensed by various sensors coupled to fixtures (e.g., shelves, bins, racks, display cases) in aisles in the store. The fixtures may include sensors, such as, cameras (e.g., a second camera 446), weight sensors, pressure sensors, heat sensors, motion detection sensors, and the like. The aisle sensor data module 130 may also be configured to operate the various sensors coupled to the fixtures. For example, the aisle sensor data module 130 may activate one or more of the cameras (e.g., second camera 446 shown in FIG. 4) coupled to or associated with the aisle (e.g., ceiling mounted cameras) to capture a second image of the customer in response to detecting that an item is being removed from the fixture by the customer. The aisle sensor data module 130 is also configured to identify the item removed from the fixture based on the data sensed by the aisle sensors. The aisle sensor data module 130 may store the sensed data in a database (e.g., database(s) 560).

The item pairing module 140 can be configured to analyze the second image of the customer to match it to one of the images captured by one or more cart cameras and stored in the database to determine that the face in the second image corresponds or matches the face in one of the first images. The item pairing module 140 may employ facial recognition techniques. The item pairing module 140 is also configured to identify the cart processing device associated to the customer whose face is captured in the first image, and transmit product information for the item removed from the fixture to the identified cart processing device to pair the removed item with the customer's cart.

The item identifier module 150 can be configured to analyze the data sensed by the cart sensors and identify the item placed in the cart by the customer. The item identifier module 150 can also be configured to generate item parameters relating to the item placed in the cart. The item parameters can be stored at the processing device or in a database.

The item counter module 160 can be configured to maintain a count of items placed in the shopping cart based on data sensed and stored by the cart sensor data module 120. The item counter module 160 is configured to maintain the count of items in the cart independently of the data received by the scanner coupled to the shopping cart.

The customer behavior module 170 can be configured to track customer movement through the store via data sensed by the cart sensors and the aisle sensors.

The alert module 180 can be configured to generate and transmit an alert to an associate device (e.g., associate device 530), where the alert indicates to the associate that a manual check of the items in the customer's cart is needed. The alert may be generated based on a mismatch between the number of items sensed by the item counter module 160 and the number of items scanned by the customer at the cart and/or a risk rating of the customer.

The risk profile module 190 can be configured to manage and analyze data relating to a risk rating for a customer. The risk rating can be based on predefined data such as a mismatch between a number of items scanned at the processing device and the items detected as being placed in the cart and/or proven theft in the store. The risk profile module 190 can also update the risk rating for a customer based on an alert being generated by the alert module 180.

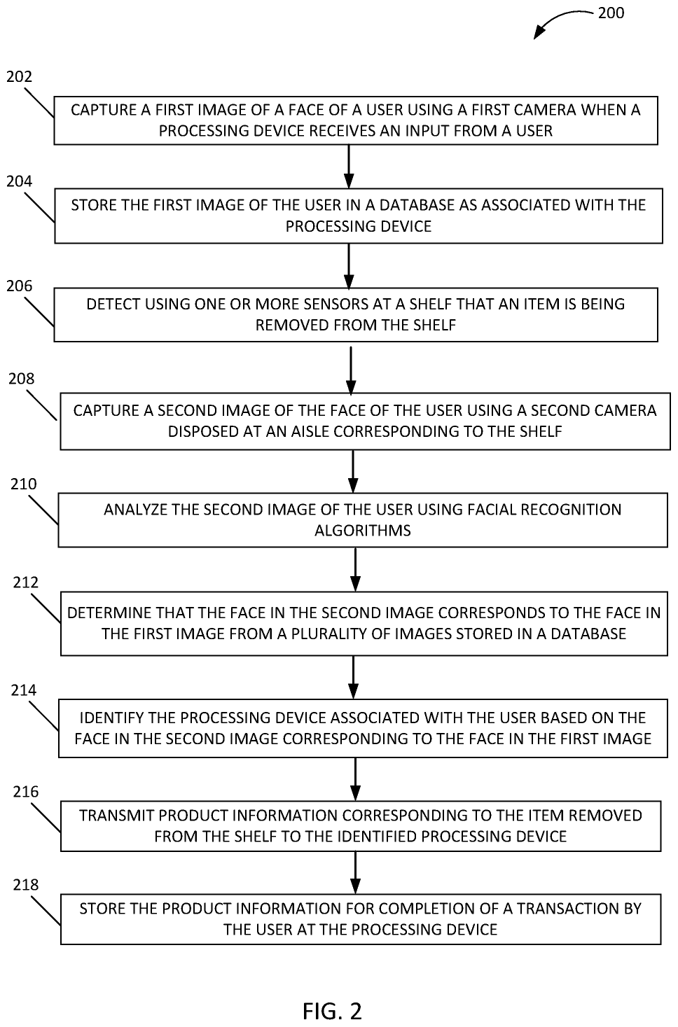

FIG. 2 is a flow chart showing an example method 200 for facilitating a transaction at a shopping cart, according to an example embodiment. The method 200 may be performed using the modules in the transaction system 100 shown in FIG. 1.

At step 202, the cart sensor data module 120 captures a first image of a face of a user using a first camera coupled to the cart when the processing device coupled to the cart receives an input from the user. The input provided by the user at the processing device may include turning on the processing device, entry of a customer identification number, customer username and password, scanning of a customer identification number, providing consent, and the like. The input, ideally provided prior to placing items in the cart, indicates to the transaction system that the customer wishes to use the processing device at the cart to complete a purchase transaction.

At step 204, the cart sensor data module 120 stores the first image is stored in a database as associated with the processing device of the cart to identify the customer using the particular cart. The database stores images of multiple users captured by cameras coupled to different carts with processing devices when the users begin using the processing device to perform transactions.

At step 206, the aisle sensor data module 130 detects, using one or more aisle sensors, that an item is being removed from the fixture (e.g., a shelf) by the user. In an example embodiment, the aisle sensor data module 130 can detect an item being removed from the shelf based on data sensed by a motion detection sensor or based on data sensed by a pressure or weight sensor near the item on the shelf. In an example embodiment, the aisle sensor data module 130 can identify the item removed from the shelf based on the location of the item on the shelf within the particular aisle.

At step 208, the aisle sensor data module 130 captures a second image of the face of the user using a second camera disposed at or within the field of view of the aisle corresponding to the shelf from which the item is being removed. The second image of the face of the customer is captured in response to the item being removed from the shelf and placed in the cart. The purpose of capturing the second image is to record the customer removing the item and placing it in the cart, and using the second image to identify the customer and/or the cart associated with that customer.

At step 210, the item pairing module 140 analyzes the second image of the user using facial recognition algorithms. Facial recognition algorithms may include the use of machine learning algorithms, facial features recognition algorithms, face detection algorithms, computer vision algorithms, Eigenfaces, Fisher-faces, Local Binary Pattern Histograms, deep convolutional neural network algorithms, and the like.

At step 212, the item pairing module 140 determines that the face in the second image corresponds to the face in the first image captured at step 202 from multiple first images of multiple users stored in the database. At step 214, the item pairing module 140 identifies the processing device associated with the user based on the face in the second image corresponding to the face in the first image. Information identifying the processing device (e.g., device identifier number or code) associated with the user may be stored in a database at step 204. At step 216, the item pairing module 140 transmits product information corresponding to the item removed from the shelf (in step 206) to the processing device identified in step 214. At step 218, the cart transaction module 110 stores the product information at the processing device for completion of a transaction by the user.

In an example embodiment, the cart sensor data module 120 detects one or more items being placed in the shopping cart, and in response generates sensed data via one or more sensors coupled to the shopping cart. The item identifier module 150 identifies the item placed in the shopping cart based on the sensed data, and generates item parameters relating to the item. In an example embodiment, the item parameters include, but are not limited to, a Universal Product Code (UPC), item dimensions, item weight, package color, and the like.

In an example embodiment, the processing device at the cart compares the item parameters generated by the item identifier module to the product information stored at the processing device. The processing device may determine whether a mismatch exists between the item parameters and the product information.

Based on a mismatch existing between the item parameters and product information, the processing device transmits instructions to an associate device, where the instructions indicate to an associate to perform a manual inspection of the items in the customer's shopping cart before the customer departs from the store.

In an example embodiment, the processing device compares the item parameters generated by the item identifier module to the product information stored at the processing device, and determines that a mismatch does not exist between the item parameters and the product information. The server analyzes multiple images of the customer captured by cameras disposed within the store (including aisle cameras and cart cameras), based on the processing device determining that a mismatch does not exist

In an example embodiment, the item counter module 160 is implemented at the cart processing device, and determines, based on the sensed data, a first number of items currently in the shopping cart. The item counter module 160 receives data from a scanning device (e.g., a scanner coupled to the cart or the customer's mobile device), where the data corresponds to one or more machine-readable labels affixed to one or more items that have been scanned by the customer. The item counter module 160 determines a second number based on the data, where the second number corresponds to a quantity of the one or more items scanned by the scanning device. The cart transaction module 110 receives an input requesting completion of a transaction for the one or more items in the shopping cart, and determines that a mismatch exists between the first number of items determined to be in the shopping cart and the second number of items scanned by the scanning device. The alert module 180 retrieves a risk rating for the user associated with the shopping cart in response to determining that the mismatch exists, and transmits instructions to an associate device based on the risk rating to indicate to an associate to perform a manual inspection of one or more items in the shopping cart. The instructions may also include the customer's location within the store. The customer's location may be determined based on the customer's mobile device or based on a location sensor coupled to the shopping cart or based on the location of the camera that captured the most recent image of the customer within the store.

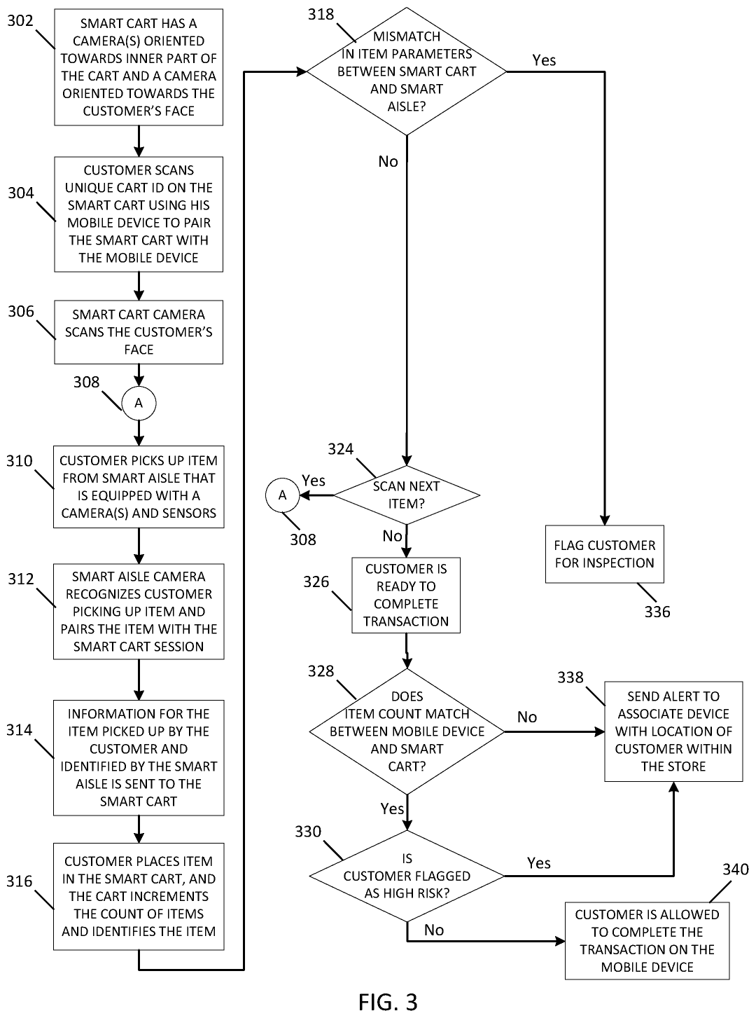

FIG. 3 is a flow chart showing an example method 300 for facilitating a transaction at a shopping cart, according to an example embodiment. At block 302, a customer selects a shopping cart that is coupled to one or more cameras (referred to herein as a “smart cart”). The cameras on the smart cart may be oriented towards an inner part of the cart and towards the customer's face. At block 304, the customer scans a unique cart identifier (e.g., barcode, QR code, alphanumerical text, etc.) with his mobile device to pair the smart cart with the mobile device. At block 306, the camera on the smart cart scans the customer's face. Steps 302, 304 and 306 are performed prior to placing items in the cart to establish a smart cart session and to associate a specific smart cart with a customer and his mobile device.

At block 310, the customer picks up an item from an aisle equipped with cameras and sensors (referred to herein as a “smart aisle”). At block 312, a camera at the smart aisle recognizes the customer picking up the item from the shelf and pairs the item with the smart cart session associated with the recognized customer. The transaction system may recognize the customer as described in connection with method 200 herein.

At block 314, information for the item picked up by the customer and identified by the smart aisle is sent to the smart cart associated with the customer recognized in block 312. At block 316, the customer places the item in the smart cart and the processing device at the cart increments the count of items in the cart. The processing device also identifies the item placed in the cart using data sensed by the sensors at the cart.

At block 318, a server in communication with the processing device, the customer's mobile device and the aisle sensors, determines if there is a mismatch between the item parameters sensed by the smart cart when the item is placed in the cart by the customer and the item parameters sensed by the smart aisle when the item is removed from the shelf by the customer. If there is no mismatch, then the method 300 proceeds to block 324. In some embodiments, if there is no mismatch in the item parameters at the smart cart and the smart aisle, but the item has certain item parameters (e.g., size of the item, price of the item, etc.), then the customer is flagged for a manual inspection and the customer's risk rating is updated to high. In this case, the flag data may indicate performing a thorough manual inspection of the items in the cart. The server may flag the customer for inspection by updating a data field associated with the customer in a database that is retrieved prior to the customer completing the purchase transaction.

If there is a mismatch in the item parameters at block 318, then the method 300 proceeds to block 336 where the customer is flagged for inspection. The customer's risk rating may also be updated to high risk. As such, if there is a mismatch in the item parameters at the smart cart and the smart aisle, then the customer is flagged for a manual inspection. In this case, the flag data may indicate performing a cursory inspection or a thorough manual inspection of the items in the cart. For example, the customer may have forgotten to scan an item at the cart or the item parameters generated by the smart cart or the smart aisle may have been erroneous.

The method 300 proceeds to block 324, where the customer is prompted to scan the next item. That is, when there is no mismatch in the item parameters at the smart cart and the smart aisle, the customer is allowed to scan the next item. If the customer scans the next item, the method 300 loops back to block 308.

If the customer does not scan another item at block 324, then at block 326 the processing device determines that the customer is ready to complete the transaction. At block 328, the processing device at the cart determines if the item count sensed by the smart cart matches the item count scanned at the mobile device. If the there is a mismatch in the item count, then at block 338 an alert is generated and transmitted to an associate's device. The alert may indicate to the associate to perform a manual inspection of the customer's cart. The alert may also include the customer's location within the store.

If there is no mismatch in the item count at block 328, then at block 330 the server determines if the customer is flagged for a manual inspection and/or the customer's risk rating indicates that the customer is high risk. If the customer is flagged for inspection and/or the customer is high risk, then at block 338 an alert is generated and transmitted to an associate's device. The alert may indicate to the associate to perform a manual inspection of the customer's cart. The alert may also include the customer's location within the store.

If the customer is not flagged for inspection and the customer is not high risk, then at block 340 the customer is allowed to complete the transaction and tender payment for the items using his mobile device.

FIG. 4 is a schematic depicting exemplary components of the transaction system, according to an example embodiment. As shown, a shopping cart 400 is coupled to a processing device 410 and a camera 445. The camera 445 is configured to capture a first image of the user. Sensors 415 are disposed at the shopping cart 400 to sense data and detect items being placed in the shopping cart 400. The user's mobile device 420 is in communication with the processing device 410.

As shown, shelves 402 hold or store various items 403 that a user can purchase. Cameras 446 are disposed at various locations at the shelves. The cameras 446 are configured to capture a second image of the user when the user removes the item 403 from the shelves 402. The cameras 446 may be disposed facing towards the user (that is, towards the center of the aisle where a user typically walks) so the cameras 446 can capture the face of the user. Sensors 440 are disposed at the shelves and are configured to sense data and detect the item 403 being removed from the shelves 402.

In this manner, the transaction system described herein facilitates transactions at a shopping cart. The shopping cart is equipped with sensors that are strategically placed to detect items that are placed in the cart and removed from the cart. The shopping cart also includes one or more cameras to capture an image of the customer's face. These cameras and sensors are in communication with to a processing device coupled to shopping cart. The processing device is in wireless communication or Bluetooth communication with the customer's mobile device and a server. As the customer shops, cameras in the aisles captures an image for the customer's face when he removes an item from a shelf. The face from the aisle image is analyzed to identify the corresponding face in images captured by cart cameras. When the cart camera image is identified, product information for the item removed from the shelf is transmitted to the processing device of the cart associated with the customer. Data sensed by the cart sensors and data scanned at the processing device or mobile device is analyzed to determine if the items placed in the cart match the items scanned for purchase. The customer is flagged for manual inspection and/or the customer's risk rating is updated to be high risk based on mismatches in item data from various sources.

FIG. 5 illustrates a network diagram depicting a system 500 for implementing the transaction system, according to an example embodiment. The system 500 can include a network 505, multiple devices, for example cart processing device 410, customer mobile device 420, and associate device 530, sensors 440, cart camera 445, aisle camera 446, server 550, and database(s) 560. Each of the devices 410, 420, 530, sensors 440, cameras 445, 446, server 550, and database(s) 560 is in communication with the network 505.

In an example embodiment, one or more portions of network 505 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

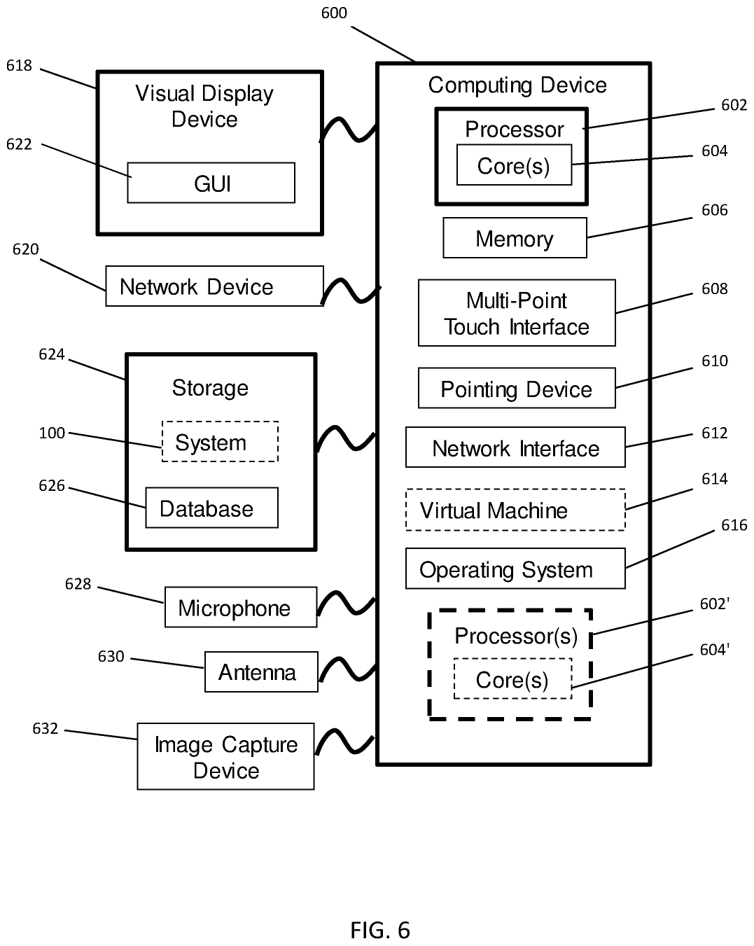

The cart processing device 410 may include, but is not limited to, an embedded computing system, a computing system with a processing device, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, mini-computers, and the like. The cart processing device 410 may connect to network 505 via a wired or wireless connection. The cart processing device 410 may communicate with the customer mobile device 420 via a wireless connection, Bluetooth connection, or near-field communication connection. The cart processing device 410 may include one or more components of computing device 600 described in connection with FIG. 6.

The mobile device 420 may include, but is not limited to, hand-held devices, portable devices, wearable computers, cellular or mobile phones, smart phones, tablets, ultrabooks, netbooks, vehicle installed or integrated computing device, and the like. The mobile device 420 may be carried by the customer while he is shopping in the store. In an example embodiment, the mobile device 420 includes a transaction app to enable the user to scan items for purchase and tender payment for the items. The mobile device 420 may connect to network 505 via a wired or wireless connection. The mobile device 420 may also include a location sensor. The mobile device 420 may include one or more components of computing device 600 described in connection with FIG. 6.

The associate device 530 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. The associate device 530 may be used by a store associate. As described herein, the associate device 530 may receive an alert when a customer is flagged for inspection, and may receive instructions to perform a manual inspection of the customer's shopping cart. The associate device 530 may include one or more components of computing device 600 described in connection with FIG. 6.

The sensors 440 may connect to network 505 via a wired or wireless connection. The sensors 440 may include the various sensors disposed at the aisles in the store. In an example embodiment, the sensors 415 (described in connection with FIG. 4) may also connect to network 505.

The cameras 445, 446 may be cameras disposed in the aisles in the store and coupled to the shopping carts. As described herein, the cameras 445, 446 are configured to capture an image of the customer's face within the store.

In an example embodiment, portions of the transaction system 100 is included on the server 550 and other portions are included on the cart processing device 410. Each of the database(s) 560, and the server 550 is connected to the network 505 via a wired connection. Alternatively, one or more of the database(s) 560, and server 550 may be connected to the network 505 via a wireless connection. Although not shown, server 550 can be (directly) connected to the database(s) 560. The server 550 includes one or more computers or processors configured to communicate with devices 510 via network 505. The server 550 hosts one or more applications or websites accessed by mobile device 420, cart processing device 410, and associate device 530, and/or facilitates access to the content of database(s) 560. Database(s) 560 comprise one or more storage devices for storing data and/or instructions (or code) for use by the server 550 and/or devices 410, 420 and 530. Database(s) 560, and/or server 550 may be located at one or more geographically distributed locations from each other or from devices 410, 420 or 530. Alternatively, database(s) 560 may be included within servers 550.

FIG. 6 is a block diagram of an exemplary computing device 600 that may be used to implement exemplary embodiments of the transaction system 100 described herein. The computing device 600 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 606 included in the computing device 600 may store computer-readable and computer-executable instructions or software for implementing exemplary embodiments of the transaction system 100. The computing device 600 also includes configurable and/or programmable processor 602 and associated core 604, and optionally, one or more additional configurable and/or programmable processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ may each be a single core processor or multiple core (604 and 604′) processor.

Virtualization may be employed in the computing device 600 so that infrastructure and resources in the computing device may be shared dynamically. A virtual machine 614 may be provided to handle a process running on multiple processors so that the process appears to be using only one computing resource rather than multiple computing resources. Multiple virtual machines may also be used with one processor.

Memory 606 may include a computer system memory or random access memory, such as DRAM, SRAM, EDO RAM, and the like. Memory 606 may include other types of memory as well, or combinations thereof.

A user may interact with the computing device 600 through a visual display device 618, such as a computer monitor, which may display one or more graphical user interfaces 622 that may be provided in accordance with exemplary embodiments. The computing device 600 may include other I/O devices for receiving input from a user, for example, a keyboard or any suitable multi-point touch interface 608, a pointing device 610 (e.g., a mouse), a microphone 628, and/or an image capturing device 632 (e.g., a camera or scanner). The multi-point touch interface 608 (e.g., keyboard, pin pad, scanner, touch-screen, etc.) and the pointing device 610 (e.g., mouse, stylus pen, etc.) may be coupled to the visual display device 618. The computing device 600 may include other suitable conventional I/O peripherals.

The computing device 600 may also include one or more storage devices 624, such as a hard-drive, CD-ROM, or other computer-readable media, for storing data and computer-readable instructions and/or software that implement exemplary embodiments of the transaction system 100 described herein. Exemplary storage device 624 may also store one or more databases for storing any suitable information required to implement exemplary embodiments. For example, exemplary storage device 624 can store one or more databases 626 for storing information, such product information, images captured by cameras, risk ratings for customers, customer information, transaction information, sensor data, and/or any other information to be used by embodiments of the system 100. The databases may be updated manually or automatically at any suitable time to add, delete, and/or update one or more items in the databases.

The computing device 600 can include a network interface 612 configured to interface via one or more network devices 620 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 600 can include one or more antennas 630 to facilitate wireless communication (e.g., via the network interface) between the computing device 600 and a network. The network interface 612 may include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 600 may run an operating system 616, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, or another operating system capable of running on the computing device and performing the operations described herein. In exemplary embodiments, the operating system 616 may be run in native mode or emulated mode. In an exemplary embodiment, the operating system 616 may be run on one or more cloud machine instances.

The following description is presented to enable a person skilled in the art to create and use a computer system configuration and related method and article of manufacture for a transaction system to facilitate transactions at a shopping cart. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for facilitating a transaction at a shopping cart, the system comprising:
a shopping cart with a processing device including a first camera operatively coupled to the shopping cart, the first camera configured to capture a first image of a face of a user when the processing device receives an input from the user;
a second camera disposed at an aisle within a store;
one or more sensors disposed at a shelf within the aisle and in communication with the second camera, the one or more sensors configured to detect an item being removed from the shelf by the user, and the second camera configured to capture a second image of the face of the user in response the one or more sensors detecting the item being removed from the shelf by the user; and
a server in communication with the processing device, the second camera and the one or more sensors;
wherein the server is configured to:
store the first image of the user in a database as associated with the processing device to associate the user with the processing device;
analyze the second image of the user using facial recognition algorithms;
determine that the face in the second image corresponds to the face in the first image from a plurality of images stored in the database;
identify the processing device associated with the user based on the face in the second image corresponding to the face in the first image; and
transmit product information corresponding to the item removed from the shelf to the identified processing device,
wherein the processing device is configured to store the product information for completion of a transaction by the user at the processing device.

2. The system of claim 1, further comprising:
one or more sensors coupled to the shopping cart and in communication with the processing device, wherein the one or more sensors are configured to detect one or more items being placed in the shopping cart and generate sensed data based on detecting items being placed in the shopping cart.

3. The system of claim 2, further comprising:
an item identifier module implemented at the processing device configured to identify, based on the sensed data, the item placed in the shopping cart and generate item parameters relating to the item.

4. The system of claim 3, wherein the item parameters relating to the item include at least one of a Universal Product Code (UPC), dimensions, a weight, and a package color.

5. The system of claim 3, wherein the processing device is configured to:
compare the item parameters generated by the item identifier module to the product information stored at the processing device;
determine that a mismatch exists between the item parameters and the product information; and
transmit instructions to a user device based on the mismatch, the instructions indicating to an associate to perform a manual check of one or more items in the shopping cart,
wherein the server is configured to update a risk rating for the user to high risk.

6. The system of claim 3, wherein the processing device is configured to:
compare the item parameters generated by the item identifier module to the product information stored at the processing device;
determine that a mismatch exists between the item parameters and the product information; and
transmit instructions to a user device based on the mismatch, the instructions indicating to an associate to perform a manual check of one or more items in the shopping cart.

7. The system of claim 3, wherein the processing device is configured to:
compare the item parameters generated by the item identifier module to the product information stored at the processing device; and
determine that a mismatch does exist between the item parameters and the product information;
wherein the server is configured to:
analyze a plurality of images of the user captured by a set of second cameras disposed within the store, based on the processing device determining that a mismatch does exist;
transmit instructions to a user device indicating to an associate to perform a manual check of one or more items in the shopping cart; and
update a risk rating for the user to high risk.

8. The system of claim 2, further comprising:
an item counter module implemented at the processing device configured to:
determine, based on the sensed data, a first number of items currently in the shopping cart;
receive data from a scanning device corresponding to one or more machine-readable labels affixed to one or more items that have been scanned by the scanning device; and
determine a second number based on the data, the second number corresponding to a quantity of the one or more items scanned by the scanning device;
a transaction module implemented at the processing device configured to:
receive input requesting completion of a transaction for the one or more items in the shopping cart; and
determine that a mismatch exists between the first number of items determined to be in the shopping cart and the second number of items scanned by the scanning device; and
an alert module implemented at the processing device configured to:
retrieve a risk rating for the user associated with the shopping cart in response to determining that the mismatch exists; and
transmit instructions to a user device based on the risk rating to indicate to an associate to perform a manual check of one or more items in the shopping cart.

9. The system of claim 1, further comprising a risk profile module implemented at a server, the risk profile module configured to determine a risk rating for the user.

10. The system of claim 1, wherein the product information for the item includes at least one of an Universal Product Code (UPC), a name, dimensions, a weight, a package color, and a price.

11. The system of claim 1, wherein the one or more sensors disposed at the shelf includes at least one of a pressure sensor, a heat sensor, a motion detection sensor, and a weight sensor.

12. A method for facilitating a transaction at a shopping cart, the method comprising:
capturing a first image of a face of a user when a processing device including a first camera receives an input from a user, the processing device coupled to a shopping cart;
storing the first image of the user in a database as associated with the processing device to associate the user with the processing device;
detecting, using one or more sensors disposed at a shelf, that an item is being removed from the shelf by the user;
in response to detecting that the item is being removed from the shelf by the user, capturing a second image of the face of the user using a second camera disposed at an aisle corresponding to the shelf;
analyzing the second image of the user using facial recognition algorithms;
determining that the face in the second image corresponds to the face in the first image from a plurality of images stored in the database;
identifying the processing device associated with the user based on the face in the second image corresponding to the face in the first image;
transmitting product information corresponding to the item removed from the shelf to the identified processing device; and
storing the product information for completion of a transaction by the user at the processing device.

13. The method of claim 12, further comprising:
detecting that one or more items is being placed in the shopping cart using one or more sensors coupled to the shopping cart and in communication with the processing device; and
generating sensed data based on detecting the one or more items being placed in the shopping cart.

14. The method of claim 13, further comprising:
identifying, based on the sensed data, the item placed in the shopping cart; and
generating item parameters relating to the item.

15. The method of claim 14, further comprising:
comparing the generated item parameters to the product information stored at the processing device;
determining that a mismatch exists between the item parameters and the product information;
transmitting instructions to a user device based on the mismatch, wherein the instructions indicate to an associate to perform a manual check of one or more items in the shopping cart; and
updating a risk rating for the user to high risk.

16. The method of claim 14, further comprising:
comparing the generated item parameters to the product information stored at the processing device;
determining that a mismatch exists between the item parameters and the product information;
and
transmitting instructions to a user device based on the mismatch, wherein the instructions indicate to an associate to perform a manual check of one or more items in the shopping cart.

17. The method of claim 14, further comprising:
comparing the generated item parameters to the product information stored at the processing device;
determining that a mismatch does exist between the item parameters and the product information;
analyzing a plurality of images of the user captured by a set of second cameras disposed within the store, based on determining that a mismatch does exist;
transmitting instructions to a user device based on the mismatch, wherein the instructions indicate to an associate to perform a manual check of one or more items in the shopping cart; and
updating a risk rating for the user to high risk.

18. The method of claim 13, further comprising:
determining, based on the sensed data, a first number of items currently in the shopping cart;
receiving data from a scanning device corresponding to one or more machine-readable labels affixed to one or more items that have been scanned by the scanning device;
determining a second number based on the data, the second number corresponding to a quantity of the one or more items scanned by the scanning device;
receiving input requesting completion of a transaction for the one or more items in the shopping cart;
determining that a mismatch exists between the first number of items determined to be in the shopping cart and the second number of items scanned by the scanning device;
retrieving a risk rating for the user associated with the shopping cart in response to determining that the mismatch exists; and
transmitting instructions to a user device based on the risk rating to indicate to an associate to perform a manual check of one or more items in the shopping cart.

19. The method of claim 12, further comprising determining a risk rating for the user.

20. A non-transitory machine-readable medium storing instructions executable by a processing device, wherein execution of the instructions causes the processing device to implement a method for facilitating a transaction at a shopping cart, the method comprising:
capturing a first image of a face of a user when a processing device including a first camera receives an input from a user, the processing device coupled to a shopping cart;
detecting, using one or more sensors disposed at a shelf, that an item is being removed from the shelf by the user;
in response to detecting that the item is being removed from the shelf by the user, capturing a second image of the face of the user using a second camera disposed at an aisle corresponding to the shelf;
storing the first image of the user in a database as associated with the processing device to associate the user with the processing device;
analyzing the second image of the user using facial recognition algorithms;
determining that the face in the second image corresponds to the face in the first image from a plurality of images stored in the database;
identifying the processing device associated with the user based on the face in the second image corresponding to the face in the first image;
transmitting product information corresponding to the item removed from the shelf to the identified processing device; and
storing the product information for completion of a transaction by the user at the processing device.
